(19) United States
(12) Patent Application Publication
(10) Pub. No.: US 2001/0035098 A1
(43) Pub. Date: Nov. 1, 2001

(54) Non-soot Chinese pan for stir-frying

(76) Inventor: Genfa Peng, Sanming City (CN)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/728,611

(22) Filed: Nov. 29, 2000

(30) Foreign Application Priority Data
Apr. 27, 2000 (CN) 00234236.7
Apr. 27, 2000 (CN) 00234237.5
Oct. 13, 2000 (CN) 00253685.4

(51) Int. Cl. A47J 37/10

(52) U.S. Cl. 99/422; 99/447

(57) ABSTRACT

A non-soot Chinese pan for stir-frying, the characteristic is in that the pan body is made of metal and with double-deck structure, between two decks of pan body heat-conducting medium the melting point of which is lower than the material of pan body is filled; also under double-deck pan body an oil tank is installed, one end of a balancing leading oil pipe is getting through into the top part of inner deck, the other end is inserted into the bottom of the oil tank and drowned in the oil layer. The advantages of the invention are: even heating of pan body, without oil-soot producing and no over heating partially; and also it could not be happened that the pressure in double-deck pan body raises due to the expansion of raised temperature of oil medium and even scalds operator due to great amount leakage of oil gas caused by too high temperature of the oil. The invention can raise the quality of dishes, insure the healthy and safety of operator.

The invention relates to an article of daily life use, more specifically to a Chinese pan for stir-frying.

People can make delicious dishes by using Chinese pan for stir-frying in daily life. However, partial double-deck or composite bottom of multi-layer metal is adopted for the known conventional Chinese pan for stir-frying. The disadvantages of this kind of pan are: small accumulation of heat, low speed of heat conducting, highly reducing speed of temperature in the pan while putting the dish into the pan during temperature raising in the pan; while cooking continuously, temperature will raise all along and soot, burnt and stick will appear so as to cause dish dehydrating heavily, outside cooked and inside raw, and effecting quality of the dish; in the meantime, a great amount of soot will produce during cooking due to uneven heating of pan body and the operator will be influenced gradually by soot, impairing people's health and polluting environment.

The object of the invention is to produce a non-soot Chinese pan for stir-frying. The pan body is heating evenly through heat conducting medium between double decks of the pan body and no soot is produced thereby raising quality of dish, insuring health of the operator, and protecting environment.

The object of the invention is achieved such that, non-soot Chinese pan for stir-frying is of double-deck pan body made of metal. Heat conducting medium is filled between two decks of pan body. The heat conducting medium is a phase transformation medium melted at 100 C and solidified below 100 C; also can be sand, graphite, metal powder; and heat conducting medium can also be heat-transfer metal sheet widened gradually along the bottom of the pan body to the top edge; the object of the invention can also be achieved such that oil medium can be filled between two decks of double deck pan body, oil tank is installed under double deck pan body, one end of balancing leading oil pipe is getting through into the top of inner deck of double deck pan body, while the other end is inserted into the bottom of the oil tank and drowned into oil layer, on the top of the oil tank relief valve is provided.

The advantages of the invention are: even heating of pan body, without oil-soot producing, no over heating partially; in the meantime it could not be happened that the pressure in the double deck pan body raises due to the expansion of raised temperature of oil medium and even scalds operator due to great amount of leakage of oil gas caused by too high temperature of the oil. The invention can raise the quality of dish, insure the healthy and safety of operator.

FIG. 1 is a sketch view of structure of the invention.

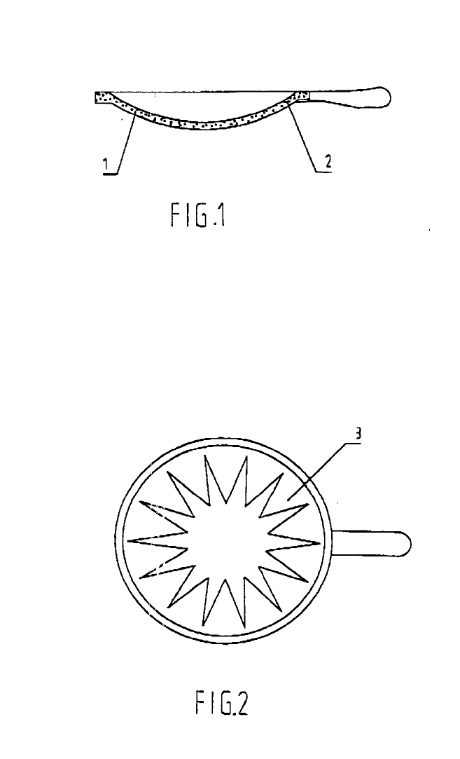

FIG. 2 is a structural sketch view of the bottom of double deck pan body for which the heat-conducting medium is heat-transfer metal sheet.

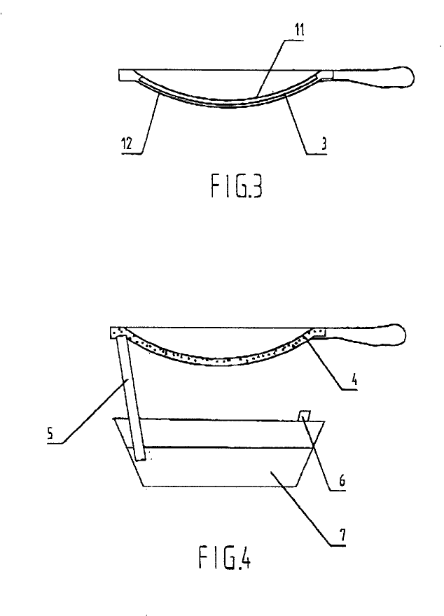

FIG. 3 is a sectional view of double deck pan body for which the heat-conducting medium is heat-transfer metal sheet

FIG. 4 is another embodiment of the invention.

For further understanding of the invention, more detailed descriptions with reference of accompany drawings are as follows.

As shown in FIG. 1, double deck pan body 1 is hollow double deck structure. The upper and lower decks of double-deck pan body 1 is made of metal and the shape of it is similar to the shape of conventional pan. Heat conducting medium 2 is filled between two decks of double-deck pan body 1. Heat conducting medium 2 is phase transformation medium melted at 100 C and solidified below 100 C. This kind of phase transformation medium is non-metal composition. One of its elements is volume expansion during heating and melting, while the other is volume diminution during heating and melting. During temperature reducing and heat conducting medium 2 solidifying one of its elements is volume diminution while the other is volume expansion to insure the volume of the heat conducting medium 2 constant before and after heating. During cooking, as the temperature raising heat conducting medium 2 starts to melt and absorb heat thereby the temperature will not raise too fast.

The heat-conducting medium 2 between two decks of double-deck pan body 1 can also be sand, graphite, and metal powder. Filling above-mentioned medium, double-deck pan body 1 could be heated faster and more even. When dish and other flavoring are put into the pan, since heat-conducting medium 2 can keep temperature for a period of time and also has the function of heat accumulation thereby the temperature in the pan could not reduce immediately. The object of stir-frying dish very quickly could be achieved thereby the stir-fried dish will be crisper, outer-sweet smell and inner-tender.

As shown in FIGS. 2 and 3, at the outer side of inner deck 11 of double-deck pan body 1 heat-transfer metal sheet 3 widened toward upper edge gradually could be attached such that when pan body 1 is heated, the temperature at the upper edge of pan body 1 is lower and through this method the whole pan body is heated evenly, thereby the difference of temperature between center of upper deck of pan body 1 and all around is small. Since double-deck pan body 1 could be over heating, therefore oil soot could not also be produced. Heat-transfer metal sheet could also be attached on the inner side of outer deck 12 of double-deck pan body.

The other embodiment of the invention is shown in FIG. 4. Oil medium 4 is filled between two decks of double-deck structure of pan body. An oil tank 7 is installed under double-deck pan body 1, one end of the balancing leading oil pipe 5 is getting through into the upper part of inner deck of double-deck pan body 1, while the other end is inserted into the bottom of oil tank 7 and drowned into the oil layer, on the top of oil tank 7 relief valve 6 is provided.

For this kind of non-soot Chinese pan stir-frying with oil tank 7, when using gas or electricity to heat oil medium 4 and expand, expanded gas or oil medium 4 in the double-deck pan body 1 could expand into the oil tank. Since certain amount of oil medium 4 is remained in the oil tank 7, thereby the temperature of mixed oil is not very high. When the gas in the top part of oil tank 7 is discharged through relief valve, a small amount of oil gas is brought away. In the event of too high temperature of non-soot Chinese pan for stir-frying, oil and oil gas can all be discharged into the oil tank 7 through balancing leading oil pipe 5 and no danger could be happened. When temperature in the non-soot Chinese pan for stir-frying reduces, the volume of oil medium 4 in double-deck pan body 1 diminishes; the oil medium 4 in oil tank 7 is inhaled into double-deck pan body 1 through balancing leading oil pipe 5 and air can not be inhaled. During cooking balancing leading oil pipe 5 has to be sealed, otherwise oil medium 4 in the oil tank 7 could not be inhaled into the double-deck pan body 1, the amount of oil in the oil tank 7 has to be kept to seal the lower end of balancing leading oil pipe 7. During using the embodiment, the temperature of pan body is even, heat accumulation is big. Oil soot is few during cooking. Color, smell and taste are all excellent

1. A non-soot Chinese pan for stir-frying, the characteristic is in that pan is of double-deck structure made of metal, heat-conducting medium 2 the melting point of which is lower than the one of pan body material is filled between two decks of double deck pan body 1.

2. According to claim 1 said non-soot Chinese pan for stir-frying, the characteristic is in that heat-conducting medium 2 is phase transformation medium melted at 100 C and solidified below 100 C.

3. According to claim 1 or 2 said non-soot Chinese pan for stir-frying, the characteristic is in that heat-conducting medium 2 is a kind of non-metal composition one of the elements of which is volume expansion and the other is volume diminution during heating.

4. According to claim 1 said non-soot Chinese pan for stir-frying, the characteristic is in that heat-conducting medium 2 is sand, graphite, and metal powder and so on.

5. According to claim 1 said non-soot Chinese pan for stir-frying, the characteristic is in that heat-conducting medium 2 is heat-transfer metal sheet 3 widened along the bottom of pan body toward upper edge gradually.

6. According to claim 5 said non-soot Chinese pan for stir-frying, the characteristic is in that heat transfer metal sheet 3 is attached on the inner side of outer deck 12 of pan body.

7. According to claim 5 said non-soot Chinese pan for stir-frying, the characteristic is in that heat transfer metal sheet 3 is attached on the outer side of inner deck 11 of pan body.

8. According to claim 1 said non-soot Chinese pan for stir-frying, the characteristic is in that oil medium 4 is filled between two decks of double deck pan body, an oil tank 7 is installed under the pan body 1; one end of balancing leading oil pipe 5 is getting through into the upper part of inner deck of double deck pan body 1, while the other end is inserted into the bottom of oil tank 7 and drown in oil layer; relief valve 6 is provided on the upper part of oil tank 7.
